(19) United States
(12) Patent Application Publication
(10) Pub. No.: US 2023/0072586 A1
(43) Pub. Date: Mar. 9, 2023

(54) GUIDANCE DEVICE, GUIDANCE METHOD, AND PROGRAM

(71) Applicant: SONY GROUP CORPORATION, TOKYO (JP)

(72) Inventors: NAOYUKI SATO, TOKYO (JP); KUNIAKI TORII, TOKYO (JP); KAZUNORI YAMAMOTO, TOKYO (JP); KAZUMI SATO, TOKYO (JP)

(21) Appl. No.: 17/794,893

(22) PCT Filed: Dec. 18, 2020
(86) PCT No.: PCT/JP2020/047433

§ 371 Date: Jul. 22, 2022

(30) Foreign Application Priority Data
Jan. 30, 2020 (JP) 2020-013528

(51) Int. Cl. B25J 11/00; G01C 21/34; G01C 21/36; B25J 9/16; B25J 19/02; G06T 7/70; G06V 40/10; G06V 40/20

(52) U.S. Cl. CPC B25J 11/0005; G01C 21/3484; G01C 21/3617; G01C 21/3602; G01C 21/3647; B25J 9/1666; B25J 19/023; G06T 7/70; G06V 40/10; G06V 40/20; G06T 2207/30196

(57) ABSTRACT

A behavioral ability obtainment unit 351 obtains behavioral abilities including, for example, at least one of physical behavioral abilities and intellectual behavioral abilities, of a plurality of members, i.e., members of a group to be guided. A guidance control unit 352 performs guidance control for the group on the basis of the behavioral abilities obtained by the behavioral ability obtainment unit 351. For example, the guidance control unit determines a member to be prioritized from the group members, generates a route plan to a destination according to the behavioral abilities of the determined member to be prioritized, and performs guidance control based on the route plan. This makes it possible to perform guidance operations according to the group to be guided.

### TECHNICAL FIELD

The present technique relates to a guidance device, a guidance method, and a program which enable guidance to be performed according to a group to be guided.

### BACKGROUND ART

In the past, a guidance device for guiding a person to be guided has been disclosed. For example, a guide robot of PTL 1 is a humanoid robot having an anthropomorphic appearance, and is placed at event venues and the like to guide people to their destinations. When performing a guidance task for an unspecified number of people, the guide robot can move with its body facing backward to maintain the people's attention while providing guidance.

### CITATION LIST

### Patent Literature

[PTL 1]
JP 2011-656 A

### SUMMARY

### Technical Problem

Incidentally, when guiding a group, the members of the group to be guided may not necessarily have the same level of behavioral ability and the like, and may include, for example, members having different athletic abilities, members having different knowledge about the facility in which they are guided, and the like. As such, if the guidance operations to the destination are defined in advance, a guidance operation suited to the group to be guided cannot be performed.

Accordingly, an object of this technique is to provide a guidance device, a guidance method, and a program that can perform guidance operations according to a group to be guided.

### Solution to Problem

A first aspect of the present technique is

a guidance device including:

a behavioral ability obtainment unit that obtains behavioral abilities of a plurality of members; and

a guidance control unit that performs guidance control for the plurality of members based on the behavioral abilities obtained by the behavioral ability obtainment unit.

In the present technique, the behavioral ability obtainment unit obtains behavioral abilities including, for example, at least one of physical behavioral abilities and intellectual behavioral abilities, of the plurality of members. The guidance control unit performs guidance control for the plurality of members based on the behavioral abilities obtained by the behavioral ability obtainment unit. Additionally, the guidance control unit determines a member to be prioritized from the plurality of members, generates a route plan to a destination according to the behavioral abilities of the determined member to be prioritized, and performs guidance control based on the route plan. The member to be prioritized may be determined based on the behavioral abilities of the members, or based on profiles of the members.

The guidance control unit recognizes the plurality of members and performs guidance control by detecting a person region from a captured image obtained by capturing surroundings and determining which member the person region indicates based on a feature calculated from an image of the person region, such as, for example, a color histogram. In the guidance control, the guidance control unit detects positions of the plurality of members based on an object recognition result obtained using a range sensor and a member recognition result obtained using the captured image. Additionally, the guidance control unit determines a breakaway member based on a detection result of the positions of the plurality of members and performs a warning operation in accordance with the behavioral abilities of the breakaway member that has been determined. Additionally, when an obstacle has been detected, the guidance control unit generates a route plan that avoids the obstacle in accordance with the behavioral abilities of the plurality of members, and performs the guidance control based on the route plan generated.

A second aspect of the present technique is

a guidance method including:

obtaining behavioral abilities of a plurality of members using a behavioral ability obtainment unit; and

performing guidance control for the plurality of members using a guidance control unit based on the behavioral abilities obtained by the behavioral ability obtainment unit.

A third aspect of the present technique is

a program that causes a computer to execute guidance control, the program including:

a process of obtaining behavioral abilities of a plurality of members; and

a process of performing guidance control for the plurality of members based on the behavioral abilities obtained.

The program of the present technique is a program that can be provided in a general-purpose computer capable of executing various program codes by a storage medium provided in a computer-readable format or a communication medium, for example, a storage medium such as an optical disk, a magnetic disk or a semiconductor memory, or a communication medium such as a network.

The provision of such a program in a computer-readable format allows processing according to the program to be realized on the computer.

### BRIEF DESCRIPTION OF DRAWINGS

FIG. 1 is a diagram illustrating an example of the configuration of a system using a guidance device.

FIG. 2 is a diagram illustrating an example of the configuration of the guidance device.

FIG. 3 is a flowchart illustrating an example of operations by a control unit.

FIG. 4 is a flowchart illustrating an example of route plan generation operations.

FIG. 5 is a flowchart illustrating an example of movement control operations.

FIG. 6 is a flowchart illustrating another example of movement control operations.

FIG. 7 is a diagram illustrating query operations for a highest-ranked member.

FIG. 8 is a flowchart illustrating an example of obstacle avoidance operations.

FIG. 9 is a flowchart illustrating an example of route plan generation operations using obstacle information.

FIG. 10 is a flowchart illustrating an example of breakaway response operations.

FIG. 11 is a flowchart illustrating an example of member registration operations.

FIG. 12 is a diagram illustrating an example of a color histogram.

FIG. 13 is a flowchart illustrating an example of member tracking operations.

### DESCRIPTION OF EMBODIMENTS

An embodiment of the present technique will be described below. The descriptions will be given in the following order.

1. System Configuration

2. Guidance Device Configuration

3. Guidance Device Operations

3-1. Route Plan Generation Operations of Guidance Device

3-2. Movement Control Operations of Guidance Device

3-3. Other Movement Control Operations of Guidance Device

3-4. Obstacle Avoidance Operations

3-5. Breakaway Response Operations

3-6. Member Identification Processing

<1. System Configuration>

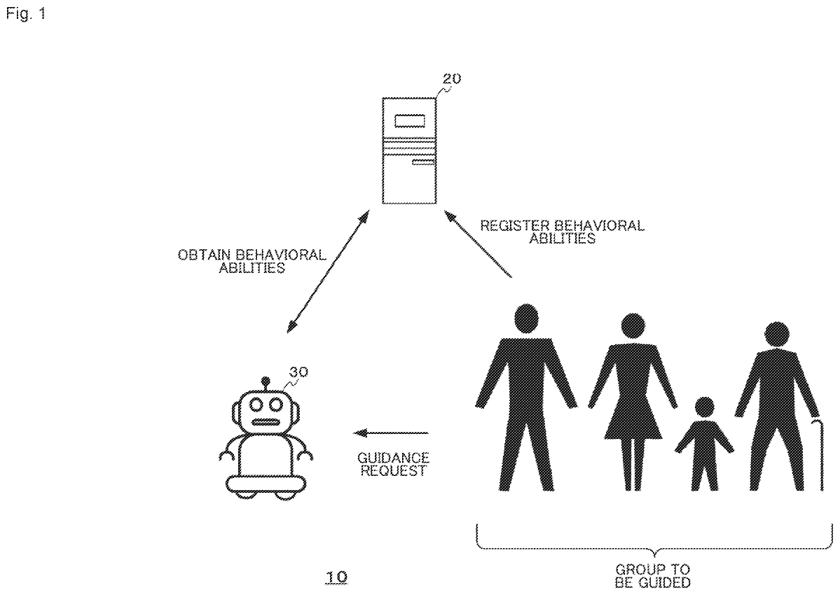

FIG. 1 illustrates an example of the configuration of a system using the guidance device of the present technique. A system 10 includes a database 20 in which the behavioral abilities of a plurality of members constituting a group to be guided are stored, and a guidance device 30 that guides the group to a destination based on the behavioral abilities of each member of the group in response to a guidance request from the group.

The database 20 registers the behavioral abilities of the members in response to requests from the members, for example. A mobile communication terminal, such as a smartphone, carried by the member determines the behavioral abilities through an application. Furthermore, the mobile communication terminal communicates with the database 20 to register the member's behavioral abilities in the database 20. The mobile communication terminal may also register a profile of the member in the database 20. The database 20 provides the behavioral abilities and the like of the group members to the guidance device 30 in response to a request from the guidance device 30.

Based on a guidance request from the group, for example, the guidance device 30 obtains the behavioral abilities of each member of the group and provides guidance by setting a route to a destination based on the obtained behavioral abilities. The guidance device 30 may also perform breakaway response operations, obstacle avoidance operations, and the like while moving.

<2. Guidance Device Configuration>

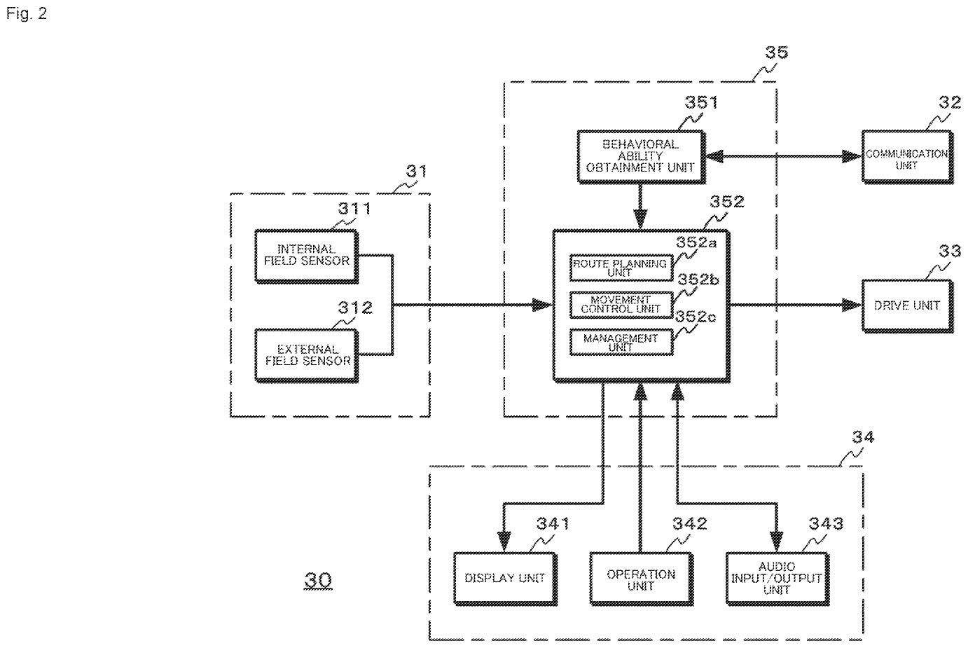

FIG. 2 illustrates an example of the configuration of the guidance device. The guidance device 30 includes a sensor unit 31, a communication unit 32, a drive unit 33, a user interface unit 34, and a control unit 35.

The sensor unit 31 includes an internal field sensor 311 and an external field sensor 312, and obtains sensing data for estimating a self-position, ascertaining the surrounding environment, and the like.

The internal field sensor 311 is constituted by a position sensor, an angle sensor, an accelerometer, a gyrosensor, an Inertial Measurement Unit (IMU) sensor, or the like, and obtains sensing data about the guidance device itself and outputs the sensing data to the control unit 35.

The external field sensor 312 is constituted by a range sensor (LIDAR (Light Detection and Ranging)), an image sensor, or the like, and obtains sensing data about the surrounding environment of the guidance device 30 and outputs the sensing data to the control unit 35.

The communication unit 32 communicates with external devices. The communication unit 32 communicates wirelessly with the database 20, for example, over a network or the like to obtain the behavioral abilities of each member from the database 20 and output the behavioral abilities to the control unit 35. In addition, the communication unit 32 communicates wirelessly with group members, obtains group requests, information on group members, and the like, and outputs that information to the control unit 35.

The drive unit 33 moves the guidance device 30 by driving actuators, wheels, and the like based on drive control signals supplied from the control unit 35.

The user interface unit 34 is constituted by a display unit 341, an operation unit 342, an audio input/output unit 343, and the like.

The display unit 341 displays menus for operation settings and the like of the guidance device 30, presents various information during guidance operations, and the like.

The operation unit 342 is constituted by operation switches, operation buttons, a touch panel, a code reader, and the like. The operation unit 342 enables various setting operations of the guidance device 30, the acceptance of information related to guidance, the acceptance of information such as a destination and member profiles, and the like. For example, when requesting guidance at an airport, a boarding gate is set as the destination by reading a code shown on the ticket. It may also be possible to read codes indicating information about a user profile and behavioral abilities generated by an application on a mobile communication terminal such as a smartphone, and use these codes for guidance control.

The audio input/output unit 343 is constituted by a speaker, a microphone, and the like. The audio input/output unit 343 outputs audio information related to guidance operations and the like from the speaker. The audio input/output unit 343 accepts voice instructions and the like from group members and the like based on the voice obtained by the microphone.

The control unit 35 performs guidance operations up to the destination based on the behavioral abilities of the group members in response to a request from the group made via the communication unit 32 or the user interface unit 34.

The control unit 35 includes a behavioral ability obtainment unit 351 that obtains the behavioral abilities of the plurality of members, and a guidance control unit 352 that controls the guidance of the plurality of members based on the behavioral abilities obtained by the behavioral ability obtainment unit 351. The guidance control unit 352 includes a route planning unit 352a, a movement control unit 352b, and a management unit 352c, as will be described below.

The behavioral ability obtainment unit 351 obtains the behavioral abilities of the group members via the communication unit 32 based on instructions from the guidance control unit 352. The behavioral ability obtainment unit 351 outputs the obtained behavioral abilities to the guidance control unit 352.

The route planning unit 352a of the guidance control unit 352 estimates the self-position of the guidance device itself based on the sensing data output from the sensor unit 31. For example, the route planning unit 352a detects the self-position using the sensing data output from the external field sensor 312 and map information stored in advance. The route planning unit 352a determines a route from a guidance start position, which is the detected self-position, to a destination indicated by the management unit 352c, taking into account the behavioral abilities of the group members. When a member to be prioritized is identified, the route planning unit 352a generates a route plan to the destination according to the behavioral abilities of the member to be prioritized.

The movement control unit 352b generates drive control signals, and outputs the drive control signals to the drive unit 33, so that the guidance device moves along the route determined by the route planning unit 352a while estimating the self-position of the guidance device itself based on the sensing data output from the sensor unit 31. For example, the movement control unit 352b detects the self-position of the guidance device 30 by determining in which direction and to what extent the guidance device 30 has moved based on the sensing data output from the internal field sensor 311. The movement control unit 352b may also detect the self-position using the sensing data output from the external field sensor 312 and map information stored in advance. The movement control unit 352b may obtain the detection result of the self-position by integrating the detection result of the self-position based on the sensing data output from the internal field sensor 311 and the detection result of the self-position based on the sensing data output from the external field sensor 312.

The movement control unit 352b generates movement control signals so as to move toward an objective at a movement speed set based on the behavioral abilities of the group members or the member to be prioritized. The member to be prioritized is communicated by the management unit 352c, for example.

Furthermore, the movement control unit 352b detects the positions of group members, obstacles, and the like based on the sensing data obtained by the external field sensor 312 of the sensor unit 31. The movement control unit 352b generates movement control signals to perform guidance operations, obstacle avoidance operations, and the like suited to the group based on the behavioral abilities, positions, and the like of the group members and the member to be prioritized, obstacle detection results, and the like.

The management unit 352c accepts guidance requests via the communication unit 32 or the user interface unit 34. Based on an objective value and group member information indicated in the guidance request, the behavioral ability obtainment unit 351, the route planning unit 352a, and the movement control unit 352b are controlled to perform the guidance operations to the destination according to the group to be guided. The management unit 352c also determines the member to be prioritized based on the behavioral abilities of the members, the profiles of the members, and the like, and notifies the movement control unit 352b of information about the determined member to be prioritized that has been (features, individual IDs (member identification codes), and the like, described later). Furthermore, the management unit 352c notifies group members of various information, instructions, and the like through images, audio, and the like using the user interface unit 34.

The configuration of the guidance control unit 352 is merely an example, and for example, the units may be configured as a single integrated entity. Additionally, in the system described above, a case where the behavioral abilities of the members and the like are obtained from the database 20 is described as an example, but the behavioral abilities may be provided to the guidance device from the mobile communication terminals of the members. For example, the mobile communication terminal of a member may use an application to generate a code indicating information such as the behavioral abilities, the profile, and the like, and by using the operation unit 342 to read the code presented by the mobile communication terminal, the guidance device 10 may obtain the behavioral abilities and the like without using the database 20.

<3. Guidance Device Operations>

Operations of the guidance device will be described next. The “group” is a group such as a family group, a company-related group, a group of friends, a group having the same objective (e.g., a package tour group, a guided group at a museum or a gallery), or the like.

The guidance device performs the guidance operations according to a member to be prioritized in the group. For example, if the group is a family group, the guidance operations are performed with children, elderly members, or the like as members to be prioritized. If the group is a company-related group, the guidance operations may be performed with the person in the highest position as the member to be prioritized; if the group is a group of friends, a member having less experience in using the facility where the guidance is performed may be the member to be prioritized, or the guidance operations may be performed without prioritizing any member. Furthermore, if the group is a group having the same objective, e.g., if grades are set for members in the group having the same objective, the guidance operations may be performed with members having the highest grade as the members to be prioritized. If the guidance device is also capable of carrying a member's luggage, the member who gave the luggage to the guidance device may be set as the member to be prioritized so as not to be separated from the luggage.

The guidance device determines the member to be prioritized based on, for example, the behavioral abilities of the members, in order to perform the guidance operations according to the member to be prioritized. The member to be prioritized may also be determined based on the profiles of the members. The “behavioral abilities” include at least one of physical behavioral abilities and intellectual behavioral abilities. Note that in the present technique, obtaining physical behavioral abilities refers to obtaining information about physical fitness, e.g., age, weight, height, gender, walking speed, physical functions, and the like. Obtaining intellectual behavioral abilities refers to obtaining information about knowledge necessary for taking action, e.g., multilingual ability, frequency of use of the facility where the guidance is performed, hobbies and interests, and the like. The information about physical behavioral abilities may include any of the above information about intellectual behavioral abilities, and the information about intellectual behavioral abilities may include any of the above information about physical behavioral abilities.

Using walking speed as the behavioral ability makes it possible for the guidance device to appropriately set a movement speed, perform obstacle avoidance operations, and the like during guidance. This also enables the guidance device to identify the elderly, children, and the like.

Walking ability, for example, uses information on the use of movement assistance implements (canes, wheelchairs, and the like). Using walking ability makes it possible for the guidance device to appropriately set a movement speed, perform obstacle avoidance operations, and the like during guidance. The guidance device can also set routes to destinations that do not require the use of stairs and the like.

Using reaction speed makes it possible for the guidance device to appropriately perform obstacle avoidance operations.

Based on age and the like, the guidance device can determine whether a member is able to move on their own, whether it is necessary to guide the member while taking into account restroom use, and the like.

Using weight, height, gender, and the like also makes it possible for the guidance device to appropriately set a movement speed, perform obstacle avoidance operations, and the like during guidance.

Using language ability makes it possible for the guidance device to determine if a member is capable of acting autonomously under different language environments. In addition, using knowledge of the facility where the guidance is performed makes it possible for the guidance device to determine if a member is capable of acting autonomously in the facility where the guidance is performed.

Furthermore, using information on hobbies and interests makes it possible for the guidance device to select a route that matches the hobbies and interests and perform the guidance operations. Furthermore, using information such as a user-specified desired stopping place makes it possible for the guidance device to perform guidance operations to the destination via a user-specified stopping place (a store, an ATM, or the like).

The behavioral abilities of the members may be set individually by the members, or may be generated automatically by applications on the mobile communication terminals owned by the members. For example, a mobile communication terminal can generate information indicating the physical behavioral abilities by detecting movements of the member using sensors. Walking speed can also be determined based on position information detected by the mobile communication terminal and elapsed time, or sensing output from an accelerometer. If the frequency of stumbles or falls detected based on an accelerometer or the like is high, or if the acceleration when transitioning from a stopped state to a walking state or from a walking state to a stopped state is low, the reaction speed may be determined to be slow. In addition, the mobile communication terminal can generate information indicating intellectual behavioral abilities about knowledge of the facility where the guidance is performed by determining the history of visits to the facility or parts of the facility based on position information or the like. Furthermore, the mobile communication terminal can generate information indicating intellectual behavioral abilities about to hobbies and interests based on an information search history of the member or the like.

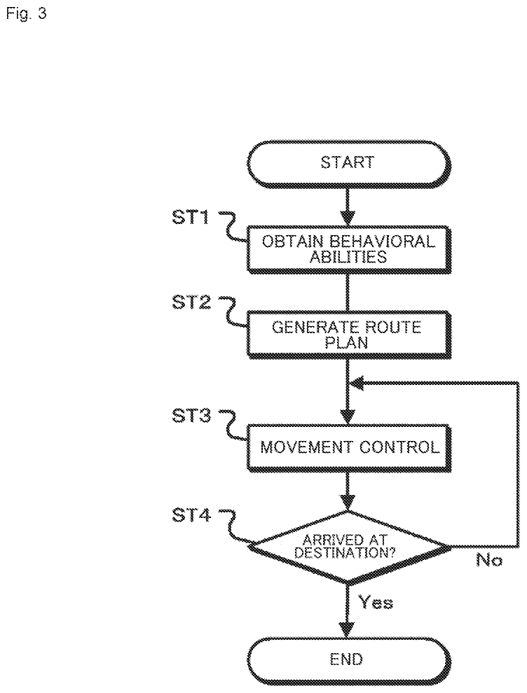

FIG. 3 is a flowchart illustrating an example of operations by the control unit. In step ST1, the control unit obtains the behavioral abilities. The behavioral ability obtainment unit 351 of the control unit 35 obtains the behavioral abilities of the group members from database 20, after which the sequence moves to step ST2.

In step ST2, the control unit generates a route plan. The guidance control unit 352 of the control unit 35 generates a route plan to the destination based on the position of the guidance device itself and the behavioral abilities of the group members.

<3-1. Route Plan Generation Operations by Guidance Device>

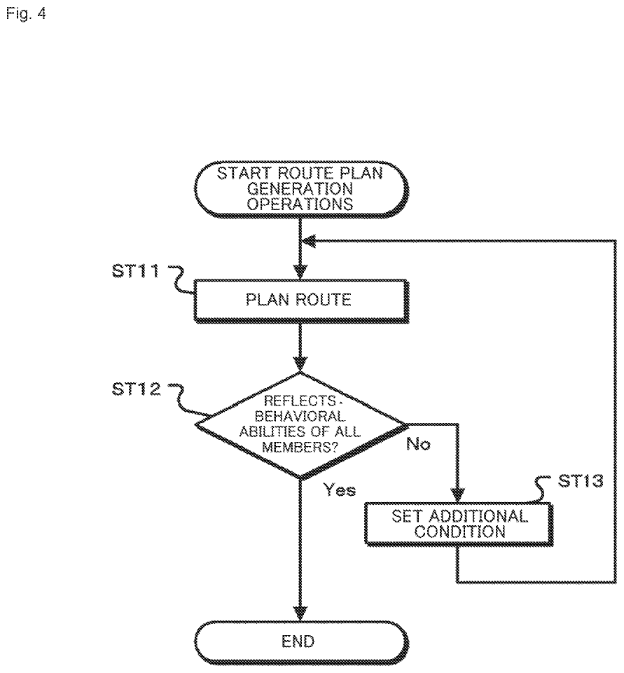

FIG. 4 is a flowchart illustrating an example of the route plan generation operations. In step ST11, the guidance control unit plans the route. The route planning unit 352a of the guidance control unit 352 detects the self-position based on the sensing data output from the sensor unit 31, and plans a route from the detected self-position to the destination, after which the sequence moves to step ST12.

In step ST12, the guidance control unit determines whether the behavioral abilities of all members are reflected. The route planning unit 352a of the guidance control unit 352 determines whether the route plan is being generated based on the behavioral abilities of all members. The route planning unit 352a ends the generation of the route plan when the route plan is being generated based on the behavioral abilities of all members. If the behavioral abilities of any member are not taken into account in the generation of the route plan, the sequence moves to step ST13.

In step ST13, the guidance control unit sets an additional condition. The route planning unit 352a of the guidance control unit 352 sets the additional condition in the generation of the route plan based on the behavioral abilities of members not taken into account in the generation of the route plan. For example, if the behavioral abilities of a member not taken into consideration in the generation of the route plan indicate that a member has a walking disability or the like, the route planning unit 352a sets an additional condition such as increasing the usage of horizontal escalators (what are known as “moving walkways”) or the like. The route planning unit 352a sets the additional condition, and the sequence then returns to step ST11.

Generating the route plan in this manner makes it possible to guide the group to its destination on a route suited to the group members.

<3-2. Movement Control Operations of Guidance Device>

Returning to FIG. 3, after the generation of the route plan is completed in step ST2, the guidance control unit 352 performs movement control in step ST3. The guidance control unit 352 controls the movement of the guidance device to the destination along the route indicated in the route plan based on the location of the guidance device itself, the route plan generated in step ST2, and the behavioral abilities obtained in step ST1.

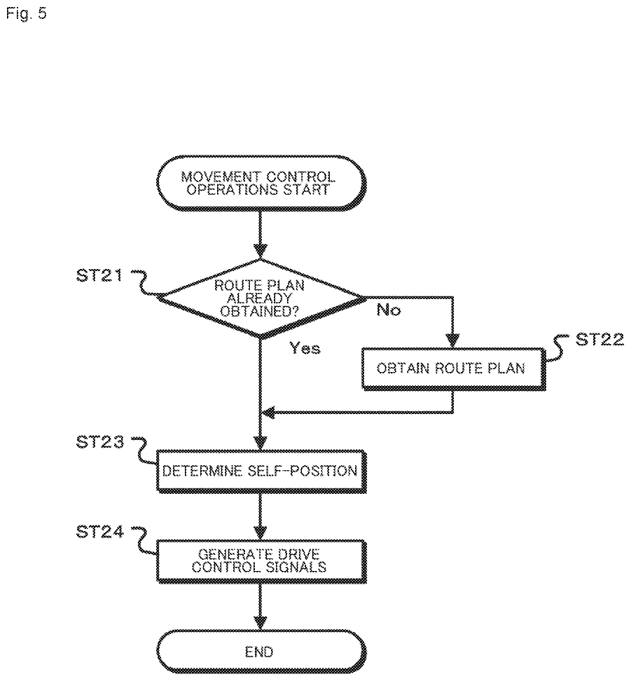

FIG. 5 is a flowchart illustrating an example of the movement control operations. In step ST21, the guidance control unit determines whether a route plan has been obtained. The sequence moves to step ST22 if the movement control unit 352b of the guidance control unit 352 has not obtained the route plan generated by the route planning unit 352a, and to step ST23 if the route plan has been obtained.

In step ST22, the guidance control unit obtains the route plan. The movement control unit 352b of the guidance control unit 352 obtains the route plan generated by the route planning unit 352a, and the sequence moves to step ST23.

In step ST23, the guidance control unit estimates the self-position. The movement control unit 352b of the guidance control unit 352 estimates the self-position of the guidance device itself based on the sensing data output from the sensor unit 31, after which the sequence moves to step ST24.

In step ST24, the guidance control unit generates drive control signals. The movement control unit 352b of the guidance control unit 352 sets the movement direction, the movement speed, and the like of the guidance device based on the self-position estimated in step ST23 and the obtained behavioral abilities, generates drive control signals so that the guidance device can travel along the planned route, and outputs the signals to the drive unit 33.

Returning to FIG. 3, in step ST4, the control unit determines whether the destination has been reached. If the guidance device has not moved to the destination, the sequence returns to step ST3, and the guidance control unit 352 of the control unit 35 continues the movement control. If the guidance device has moved to the destination, the guidance control unit 352 ends the guidance operations.

Performing such movement control makes it possible to guide the group at a movement speed suited to the group members.

<3-3. Other Movement Control Operations of Guidance Device>

Other movement control operations of the guidance device indicate a case where, for example, the group is a company-related group.

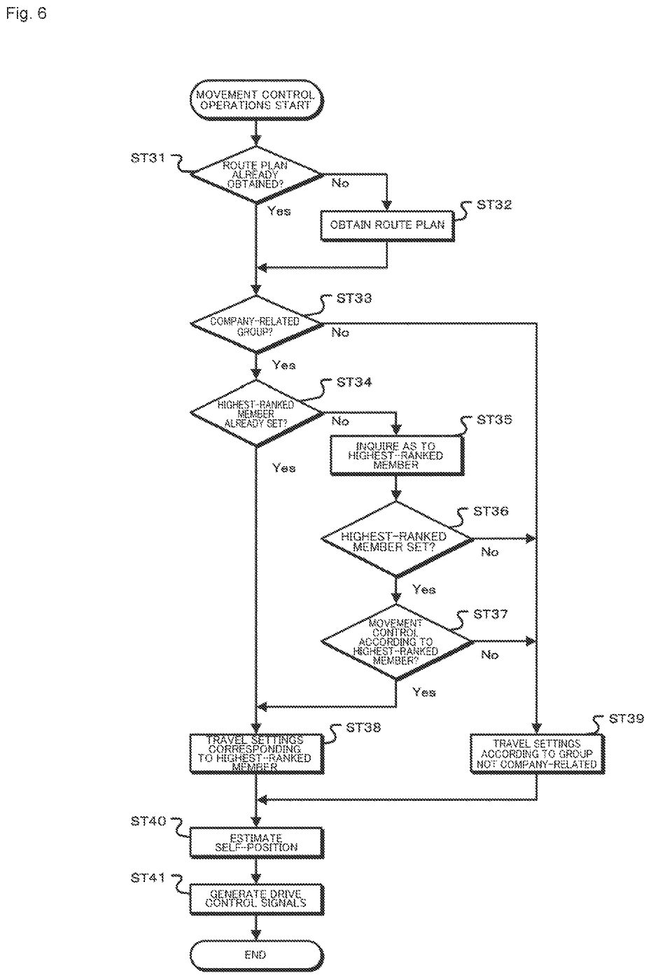

FIG. 6 is a flowchart illustrating the other example of movement control operations. In step ST31, the guidance control unit 352 determines whether a route plan has been obtained. The sequence moves to step ST32 if the movement control unit 352b of the guidance control unit 352 has not obtained the route plan generated by the route planning unit 352a, and to step ST33 if the route plan has been obtained.

In step ST32, the guidance control unit obtains the route plan. The movement control unit 352b of the guidance control unit 352 obtains the route plan generated by the route planning unit 352a, and the sequence moves to step ST33.

In step ST33, the guidance control unit determines whether the group is a company-related group. The management unit 352c of the guidance control unit 352 determines whether the group is a company-related group based on a guidance request from a user; the sequence moves to step ST34 if the group is determined to be a company-related group, and to step ST39 if the group is determined not to be a company-related group.

In step ST34, the guidance control unit determines whether a highest-ranked member has already been set. If, for example, the guidance request from the user indicates the member having the highest ranking in the group (called “highest-ranked member” hereinafter), the management unit 352c of the guidance control unit 352 notifies the movement control unit 352b of information indicating the highest-ranked member, after which the sequence moves to step ST38. If the management unit 352c determines that the highest-ranked member is not indicated, the sequence moves to step ST35.

In step ST35, the guidance control unit makes a query for the highest-ranked member. The management unit 352c of the guidance control unit 352 uses the user interface unit 34 to query, using images, audio, or the like, a user whether the highest-ranked member can be set, after which the sequence moves to step ST36.

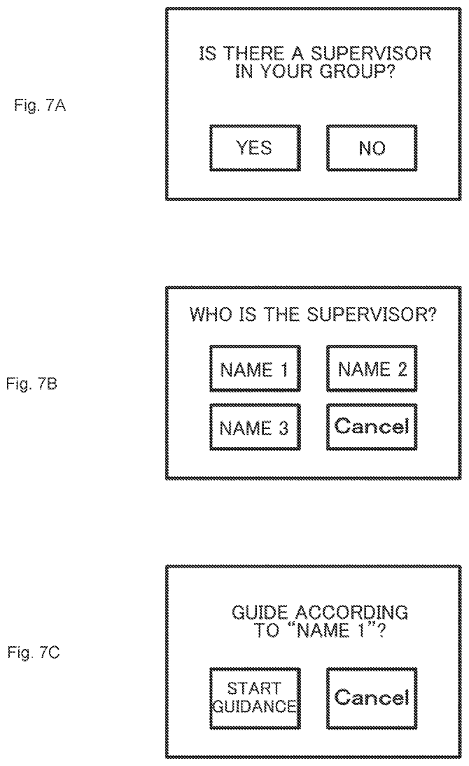

FIG. 7 is a diagram illustrating an example of query operations for the highest-ranked member. FIG. 7(a) illustrates a query screen displayed in the display unit 341 of the user interface unit 34 in the query operations for the highest-ranked member. Here, if a user operation indicates that a supervisor is present, a settings screen illustrated in FIG. 7(b) is displayed. In the settings screen display, for example, the names of the group members are displayed, and which member is the supervisor can be set.

In step ST36, the guidance control unit determines whether the highest-ranked member has been set. Upon determining that the highest-ranked member has been set in response to the query, the management unit 352c of the guidance control unit 352 notifies the movement control unit 352b of information indicating the highest-ranked member, after which the sequence moves to step ST37; if it is determined that no designation has been made, the sequence moves to step ST39.

In step ST37, the guidance control unit determines whether to perform movement control according to the highest-ranked member. The management unit 352c of the guidance control unit 352 determines whether to perform movement control corresponding to the highest-ranked member who has been set; if movement control corresponding to the highest-ranked member is to be performed, the sequence moves to step ST38, whereas if movement control corresponding to the highest-ranked member is not to be performed, the sequence moves to step ST39.

If a supervisor has been set using the settings screen display illustrated in FIG. 7(b), a selection screen is displayed to determine, for example, whether or not to perform guidance operations according to the supervisor, as illustrated in FIG. 7(c); if “start guidance” is selected, movement control is determined to be performed in accordance with the supervisor. If “cancel” is selected, it is determined that movement control in accordance with the supervisor is not to be performed.

In step ST38, the guidance control unit performs movement control according to the highest-ranked member. The movement control unit 352b of the guidance control unit 352 sets the movement speed and the like according to the behavioral abilities of the highest-ranked member, after which the sequence moves to step ST40.

In step ST39, the guidance control unit performs movement control according to a group that is not a company-related group. The movement control unit 352b of the guidance control unit 352 sets the movement speed and the like according to the behavioral abilities of each member of the group, after which the sequence moves to step ST40.

In step ST40, the guidance control unit estimates the self-position. The movement control unit 352b of the guidance control unit 352 estimates the self-position of the guidance device itself based on the sensing data output from the sensor unit 31, after which the sequence moves to step ST41.

In step ST41, the guidance control unit generates drive control signals. The movement control unit 352b of the guidance control unit 352 sets the movement direction of the guidance device based on the self-position estimated in step ST40, generates drive control signals so that the guidance device can travel along the planned route at the movement speed and the like set in step ST38 or step ST39, and outputs the signals to the drive unit 33.

Returning to FIG. 3, in step ST4, the control unit determines whether the destination has been reached. If the guidance device has not moved to the destination, the sequence returns to step ST3, and the guidance control unit 352 of the control unit 35 continues the movement control. If the guidance device has moved to the destination, the guidance control unit 352 ends the guidance operations.

The setting of the highest-ranked member is not limited to being performed through a user operation, and may be performed automatically based on information obtained over a network or the like, e.g., a company name, a department, a position, or the like indicated in a member profile obtained from a company network or a social networking service (SNS). The highest-ranked member of the group may be tentatively set based on the member profiles obtained from the communication terminal device at the time of member registration, and the tentatively-set member may be set as the highest-ranked member when there is a user instruction to make the tentatively set member the highest-ranked member.

Such movement control makes it easy to perform guidance operations in accordance with the behavioral abilities of the highest-ranked member of the group.

<3-4. Obstacle Avoidance Operations>

When guiding a group using the guidance device, the guidance device performs obstacle avoidance operations so that the group can be guided while avoiding obstacles present on the route.

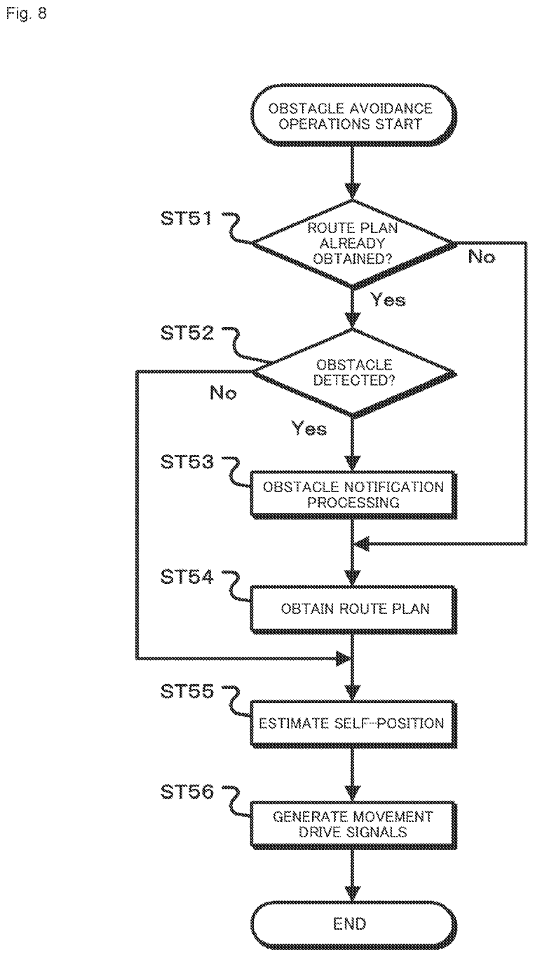

The obstacle avoidance operations will be described next. FIG. 8 is a flowchart illustrating an example of the obstacle avoidance operations.

In step ST51, the guidance control unit 352 determines whether a route plan has been obtained. The sequence moves to step ST54 if the movement control unit 352b of the guidance control unit 352 has not obtained the route plan generated by the route planning unit 352a, and to step ST52 if the route plan has been obtained.

In step ST52, the guidance control unit determines whether an obstacle has been detected. The movement control unit 352b of the guidance control unit 352 detects an obstacle located in the guidance direction based on the sensing data output from the external field sensor 312 of the sensor unit 31. The sequence moves to step ST53 if the movement control unit 352b has detected an obstacle, and to step ST55 if no obstacle has been detected.

In step ST53, the guidance control unit performs obstacle notification processing. The movement control unit 352b of the guidance control unit 352 notifies the route planning unit 352a of obstacle information indicating the position, size, movement, and the like of the detected obstacle, after which the sequence moves to step ST54.

In step ST54, the guidance control unit obtains the route plan. The movement control unit 352b of the guidance control unit 352 obtains the route plan generated based on the obstacle information generated by the route planning unit 352a, and the sequence moves to step ST55. Note that an “avoidance plan” is a shorter-term route plan than the route plan generated in step ST2.

In step ST55, the guidance control unit estimates the self-position. The movement control unit 352b of the guidance control unit 352 estimates the self-position of the guidance device itself based on the sensing data output from the sensor unit 31, after which the sequence moves to step ST56.

In step ST56, the guidance control unit generates drive control signals. The movement control unit 352b of the guidance control unit 352 sets the movement direction, the movement speed, and the like of the guidance device based on the obtained route plan, the self-position estimated in step ST55, and the behavioral abilities obtained in step ST1, generates drive control signals so that the guidance device can travel along the planned route, and outputs the signals to the drive unit 33.

Returning to FIG. 3, in step ST4, the control unit determines whether the destination has been reached. If the guidance device has not moved to the destination, the sequence returns to step ST3, and the guidance control unit 352 of the control unit 35 continues the movement control. If the guidance device has moved to the destination, the guidance control unit 352 ends the guidance operations.

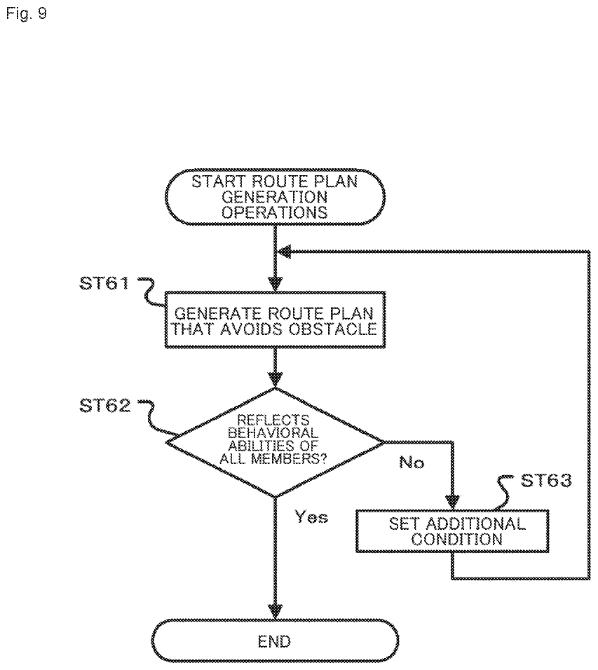

Operations of generating the route plan using the obstacle information will be described next. Upon being notified of the obstacle information by the movement control unit 352b, the route planning unit 352a of the guidance control unit 352 performs route plan generation operations using the obstacle information, such as that illustrated in FIG. 9.

In step ST61, the guidance control unit generates a route plan that avoids the obstacle. The route planning unit 352a of the guidance control unit 352 detects the self-position based on the sensing data output from the sensor unit 31, and generates a route plan that avoids the obstacle indicated by the obstacle information based on the detected self-position, e.g., a distance to start avoidance, a movement speed during avoidance, a turn angle during avoidance, and the like, after which the sequence moves to step ST62.

In step ST62, the guidance control unit determines whether the behavioral abilities of all members are reflected. The route planning unit 352a of the guidance control unit 352 determines whether the route plan that avoids the obstacle is being generated based on the behavioral abilities of all members. The route planning unit 352a ends the route plan generation operations when the route plan is being generated based on the behavioral abilities of all members. If the behavioral abilities of any member are not taken into account in the generation of the route plan, the sequence moves to step ST63.

In step ST63, the guidance control unit sets an additional condition. The route planning unit 352a of the guidance control unit 352 sets the additional condition in the generation of the route plan based on the behavioral abilities of members not taken into account in the generation of the route plan. If obstacle information has been supplied, the route planning unit 352a sets the obstacle information as the additional condition, and the sequence returns to step ST61.

By performing such movement control and route plan generation operations to avoid obstacles, if an obstacle is present on the guidance route, the route plan is updated to avoid the obstacle, and thus the group can be guided to the destination having performed obstacle avoidance operations according to the behavioral abilities of the group members and the obstacle information. Additionally, by repeating the movement control and route plan generation operations to avoid obstacles, the obstacle avoidance operations can be performed for each obstacle, even if a plurality of obstacles are present.

<3-5. Breakaway Response Operations>

When guiding a group using a guidance device, a group member may break away from the group, and thus the guidance device may perform breakaway response operations such that the group can be guided in response to the member breaking away.

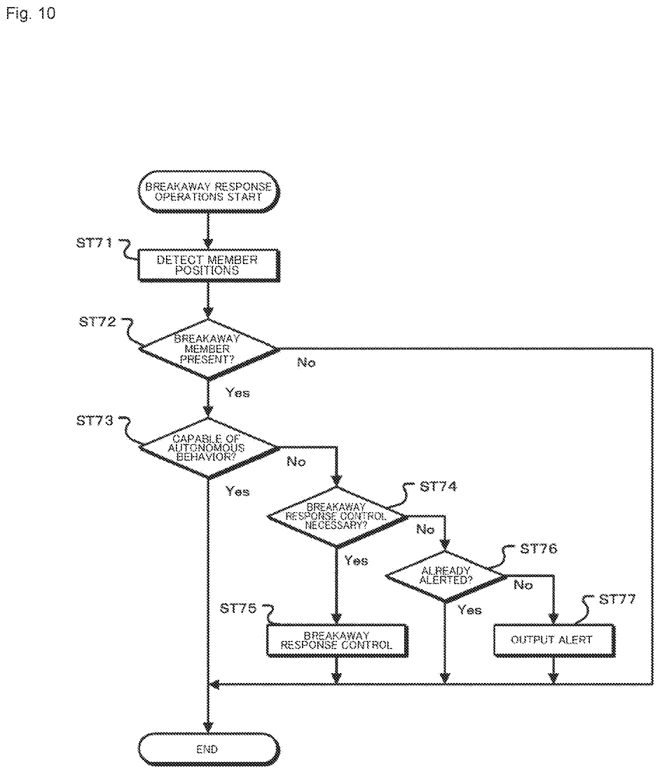

FIG. 10 is a flowchart illustrating an example of the breakaway response operations. In step ST71, the guidance control unit detects the positions of the members. The management unit 352c of the guidance control unit 352 uses the sensing data output from the external field sensor 312 of the sensor unit 31 to recognize the members and measure the distance to members for each member, after which the sequence moves to step ST72.

In step ST72, the guidance control unit determines if there is a breakaway member. If the management unit 352c of the guidance control unit 352 determines that there is a breakaway member who is further away from the guidance device than a threshold set in advance, the sequence moves to step ST73, and if there is no breakaway member, ends the breakaway response operations.

In step ST73, the guidance control unit determines whether the breakaway member is capable of autonomous behavior. If the management unit 352c of the guidance control unit 352 determines that the breakaway member is capable of behaving autonomously based on their behavioral abilities, the breakaway response operations are ended, and if the breakaway member is not capable of behaving autonomously, the sequence moves to step ST74.

In step ST74, the guidance control unit determines whether breakaway response control is required. The management unit 352c of the guidance control unit 352 determines whether guidance corresponding to the breakaway member is required based on the behavioral abilities of the breakaway member. The management unit 352c determines that the breakaway response control, which is guidance control corresponding to the breakaway member, is required when the breakaway member is a member to be prioritized in the group, e.g., an elderly person or a person with high status in the group, after which the sequence moves to step ST75; whereas if the breakaway member is not a member to be prioritized, the sequence moves to step ST76.

In step ST75, the guidance control unit performs the breakaway response control. The management unit 352c of the guidance control unit 352 notifies the to the movement control unit 352b of the breakaway member, after which the movement control unit 352b adjusts the movement speed, the movement direction, and the like of the guidance device so as not to leave the breakaway member, which completes the breakaway response operations.

In step ST76, the guidance control unit determines if a warning has been made. If the management unit 352c of the guidance control unit 352 has not output a breakaway warning from the user interface unit 34, e.g., a warning to act in accordance with the movement speed, the movement direction, and the like of the guidance device using a display, audio, or the like from the user interface unit 34, the sequence moves to step ST77, whereas if a breakaway warning has already been output, the breakaway response operations are complete.

In step ST77, the guidance control unit outputs the warning. The management unit 352c of the guidance control unit 352 outputs the breakaway warning to the breakaway member to alert the breakaway member and then ends the breakaway response operations.

By repeating these breakaway response operations, the guidance operations can be performed taking into account a breakaway member. For example, if a group includes members who do not need guidance to the destination, the system can prevent warnings and the like from being made when the members who do not need guidance leave the group. Members who need guidance can also be reminded not to leave the group. Furthermore, storing information about members who have been given breakaway warnings is stored makes it possible to prevent repeated breakaway warnings being made to the same members.

<3-6. Member Identification Processing>

Incidentally, when guiding a group, it is necessary for the guidance device to recognize the members in the group. Member recognition processing will be described next. In the member recognition processing, individual members are identified by calculating their features. In addition, individual codes are assigned to the members of a group, and individual members are managed by the individual codes. The guidance device 30 registers members using, for example, captured images, which are sensing data output from the external field sensor 312 of the sensor unit 31. In this case, the guidance device performs subject recognition using the captured images. For subject recognition, features are calculated for each member from the images captured of the members. Local features indicating edges, corners, and the like (SIFT features, SURF features, and the like) may be used as the features, or color histograms may be used as the features. The guidance device 30 recognizes at least one of the face, body shape, belongings, or the like of the member through the subject recognition and assigns an individual ID to the recognition result. The guidance device can identify each member during guidance by performing the subject recognition using images generated by the sensor unit 31 during guidance and determining the individual IDs corresponding to the calculated features.

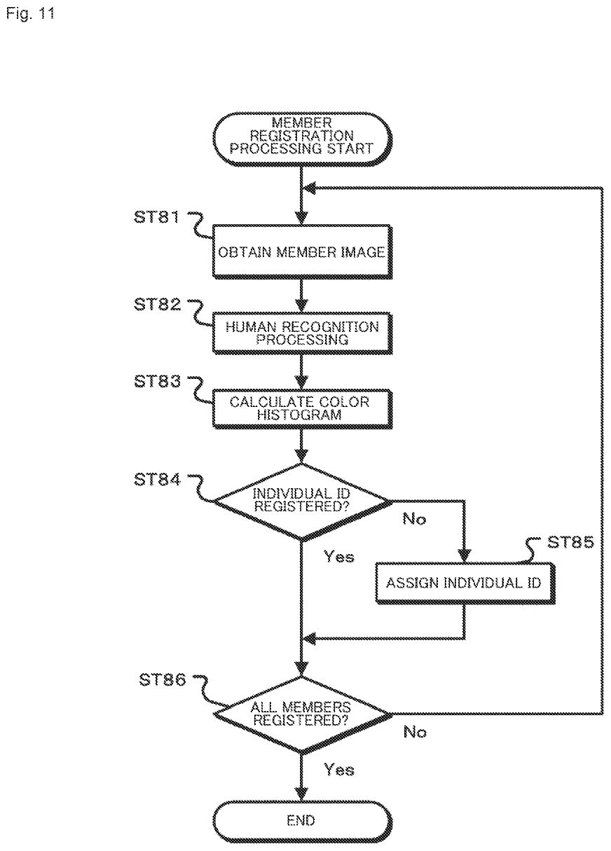

FIG. 11 is a flowchart illustrating an example of the member registration operations. In step ST81, the guidance control unit obtains a member image. The management unit 352c of the guidance control unit 352 obtains the member image of the member to be registered from the sensor unit 31, after which the sequence moves to step ST82. The “member image” may be a captured image that includes all members of a group, a plurality of captured images of individual members, or a plurality of captured images of including different pluralities of members.

In step ST82, the guidance control unit performs person recognition processing. The management unit 352c of the guidance control unit 352 performs subject recognition using the member image obtained in step ST81, and detects an image region of the member.

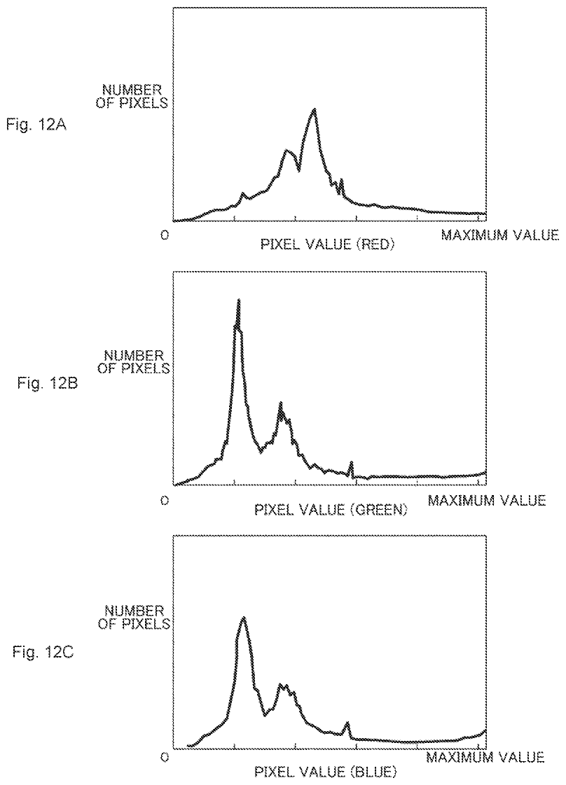

In step ST83, the guidance control unit calculates a color histogram. For example, the management unit 352c of the guidance control unit 352 calculates the color histogram by calculating a number of pixels corresponding to each of three primary color levels, after which the sequence moves to step ST84. FIG. 12 illustrates an example of a color histogram, where the horizontal axis represents pixel values and the vertical axis represents a percentage (a number of pixels). FIG. 12(a) indicates a red color component, FIG. 12(b) indicates a green color component, and FIG. 12(c) indicates a blue color component, and the total number of pixels corresponds to a number of pixels in the member image region. If the histograms are normalized so that the total numbers of pixels are equal when the region sizes of the image regions showing the same member are different, the histograms for the color components will be equal even when the region sizes of the image regions are different, which makes it possible to identify individual members using the colors of the members' clothing, personal belongings, and the like. When local features are used, it is difficult to identify users if feature points of the users are not included in subsequent captured images, but color histograms make it easier to identify individual members than when local features are used.

In step ST84, the guidance control unit determines whether the individual ID has already been registered. If the management unit 352c of the guidance control unit 352 determines that no individual ID is assigned to the color histogram calculated in step ST83, the sequence moves to step ST85, whereas if an individual ID has been assigned, the sequences moves to step ST86.

In step ST85, the control unit assigns an individual ID. The management unit 352c assigns, to the color histogram calculated in step ST83, an individual ID that is different from the other color histograms, after which the sequence moves to step ST86.

In step ST86, the control unit determines that all members have been registered. If the management unit 352c has not completed the calculation of the color histogram and the assignment of the individual ID for each member of the group, the sequence returns to step ST81, where a member image in which a member whose registration is not complete is captured is obtained, and the person recognition processing and the like are repeated. When the calculation of the color histograms and the assignment of individual IDs for each member is completed, the member registration operations are ended.

Movement control using the member recognition results will be described next.

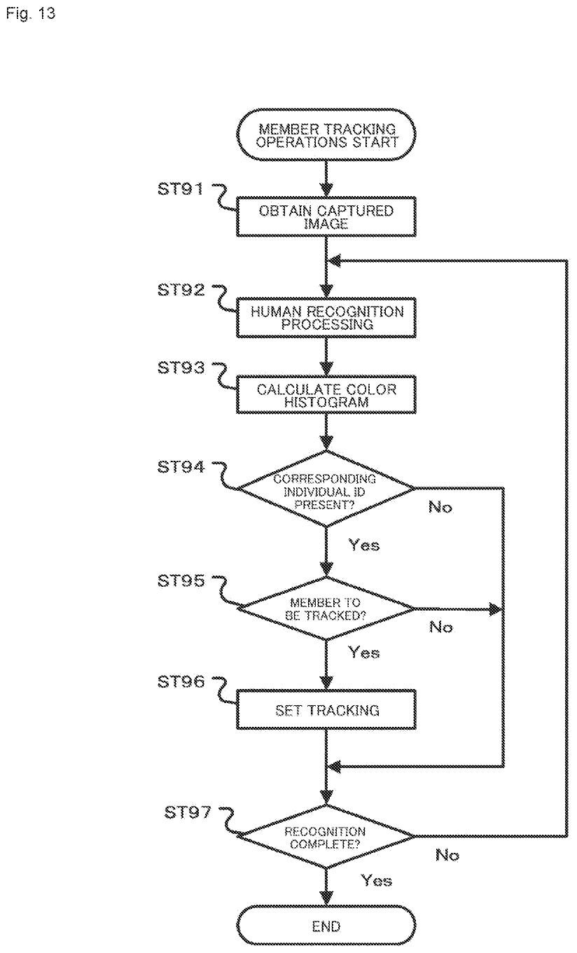

FIG. 13 is a flowchart illustrating an example of member tracking operations in the movement control.

In step ST91, the guidance control unit obtains a captured image captured during the guidance operations. The management unit 352c of the guidance control unit 352 obtains the captured image generated by capturing the surroundings using the sensor unit 31 during the guidance operations, after which the sequence moves to step ST92.

In step ST92, the guidance control unit performs person recognition processing. The management unit 352c of the guidance control unit 352 performs the person recognition processing using the captured image obtained in step ST91, and detects a person from the captured image.

In step ST93, the guidance control unit calculates a color histogram. The management unit 352c of the guidance control unit 352 calculates the color histogram based on the image of the person detected in step ST92, in the same manner as in the member registration, after which the sequence moves to step ST94.

In step ST94, the guidance control unit determines whether there is a corresponding individual ID. The management unit 352c of the guidance control unit 352 determines whether the color histogram calculated in step ST93 corresponds to one of the color histograms of the registered members, and determines the individual ID assigned to the corresponding color histogram. If the management unit 352c can determine the individual ID, the sequence moves to step ST95, and if not, the sequence moves to step ST97.

In step ST95, the guidance control unit determines whether the member is a member to be tracked. If the management unit 352c of the guidance control unit 352 determines that the individual ID determined in step ST94 is the individual ID of a member to be tracked, the sequence moves to step ST96, whereas if the individual ID is not the individual ID of the member to be tracked, the sequence moves to step ST97.

In step ST96, the guidance control unit performs tracking settings. The management unit 352c of the guidance control unit 352 sets the movement control unit 352b to perform guidance control while tracing the recognized member to be tracked, after which the sequence moves to step ST97.

In step ST97, the guidance control unit determines if the person recognition is complete. If the management unit 352c of the guidance control unit 352 has not completed the recognition of the person in the captured image, the sequence returns to step ST92, where a new person is recognized from the captured image and the processing from step ST93 is performed. If the recognition of the person in the captured image is complete, the recognition processing is terminated.

This processing makes it possible to set a member to be prioritized in the group as a member to be tracked, which in turn makes it possible for the guidance operations to be performed at a predetermined interval for the member to be prioritized. Additionally, setting each member of a group as a member to be tracked makes it possible to track the movements of each member of the group, which makes it possible to perform optimal guidance operations for the group having ascertained the individual movements of the members.

The series of processing described in the specification can be executed by hardware, software, or a composite configuration of both. When the processing is executed by software, a program in which a processing sequence has been recorded is installed in memory in a computer embedded in dedicated hardware and executed. Alternatively, the program can be installed in a general-purpose computer capable of executing various types of processing and executed.

For example, the program can be recorded in advance on a hard disk, a solid state drive (SSD), or read only memory (ROM) as a recording medium. Alternatively, the program can be temporarily or permanently stored (recorded) in a removable recording medium such as a flexible disc, a compact disc read only memory (CD-ROM), a magneto optical (MO) disc, a digital versatile disc (DVD), a Blu-ray disc (BD) (registered trademark), a magnetic disk, or a semiconductor memory card. The removable recording medium can be provided as so-called package software.

Further, the program may be transferred from a download site to the computer wirelessly or by wire via a network such as a local area network (LAN) or the Internet, in addition to being installed in the computer from the removable recording medium. The computer can receive the program transferred in this way and install the program in a recording medium such as a built-in hard disk.

The effects described in the present specification are merely examples and are not limited, and there may be additional effects not described. Further, the present technique should not be construed as being limited to the embodiments described above. The embodiments of the present technique disclose the present technique in the form of examples, and it is obvious that a person skilled in the art can modify or substitute the embodiments without departing from the gist of the present technique. That is, claims should be taken into consideration in order to determine the gist of the present technique.

The guidance device of the present technique can also have the following configurations.

(1) A guidance device including:

a behavioral ability obtainment unit that obtains behavioral abilities of a plurality of members; and

a guidance control unit that performs guidance control for the plurality of members based on the behavioral abilities obtained by the behavioral ability obtainment unit.

(2) The guidance device according to (1), wherein the guidance control unit generates a route plan to a destination in accordance with the behavioral abilities of the plurality of members, and performs the guidance control based on the route plan.

(3) The guidance device according to (2), wherein the guidance control unit determines a member to be prioritized from the plurality of members, and performs the guidance control in accordance with the member to be prioritized that has been determined.

(4) The guidance device according to (3), wherein the guidance control unit generates the route plan to the destination in accordance with the behavioral abilities of the member to be prioritized.

(5) The guidance device according to (3) or (4), wherein the guidance control unit determines the member to be prioritized based on the behavioral abilities of the members.

(6) The guidance device according to (3) or (4), wherein the guidance control unit determines the member to be prioritized based on profiles of the members.

(7) The guidance device according to any one of (1) to (6), wherein the guidance control unit recognizes the plurality of members from a captured image obtained by capturing surroundings, and performs the guidance control.

(8) The guidance device according to (7), wherein the guidance control unit detects a person region from the captured image and determines which member the person region indicates based on a feature calculated from an image of the person region.

(9) The guidance device according to (8), wherein a color histogram is used as the feature.

(10) The guidance device according to any one of (7) to (9), wherein the guidance control unit detects positions of the plurality of members based on an object recognition result obtained using a range sensor and a member recognition result obtained using the captured image.

(11) The guidance device according to (10), wherein the guidance control unit determines a breakaway member based on a detection result of the positions of the plurality of members and performs a warning operation in accordance with the behavioral abilities of the breakaway member that has been determined.

(12) The guidance device according to any one of (1) to (11), wherein when an obstacle has been detected, the guidance control unit generates a route plan that avoids the obstacle in accordance with the behavioral abilities of the plurality of members, and performs the guidance control based on the route plan generated.

(13) The guidance device according to any one of (1) to (12), wherein the behavioral abilities include at least one of physical behavioral abilities and intellectual behavioral abilities.

### REFERENCE SIGNS LIST

10 System
20 Database
30 Guidance device
31 Sensor unit
32 Communication unit
33 Drive unit
34 User interface
35 Control unit
311 Internal field sensor
312 External field sensor
341 Display unit
342 Operation unit
343 Audio input/output unit
351 Behavioral ability obtainment unit
352 Guidance control unit
352a Route planning unit
352b Movement control unit
352c Management unit

1. A guidance device comprising:
a behavioral ability obtainment unit that obtains behavioral abilities of a plurality of members; and
a guidance control unit that performs guidance control for the plurality of members based on the behavioral abilities obtained by the behavioral ability obtainment unit.

2. The guidance device according to claim 1,
wherein the guidance control unit generates a route plan to a destination in accordance with the behavioral abilities of the plurality of members, and performs the guidance control based on the route plan.

3. The guidance device according to claim 2,
wherein the guidance control unit determines a member to be prioritized from the plurality of members, and performs the guidance control in accordance with the member to be prioritized that has been determined.

4. The guidance device according to claim 3,
wherein the guidance control unit generates the route plan to the destination in accordance with the behavioral abilities of the member to be prioritized.

5. The guidance device according to claim 3,
wherein the guidance control unit determines the member to be prioritized based on the behavioral abilities of the members.

6. The guidance device according to claim 3,
wherein the guidance control unit determines the member to be prioritized based on profiles of the members.

7. The guidance device according to claim 1,
wherein the guidance control unit recognizes the plurality of members from a captured image obtained by capturing surroundings, and performs the guidance control.

8. The guidance device according to claim 7,
wherein the guidance control unit detects a person region from the captured image and determines which member the person region indicates based on a feature calculated from an image of the person region.

9. The guidance device according to claim 8,
wherein a color histogram is used as the feature.

10. The guidance device according to claim 7,
wherein the guidance control unit detects positions of the plurality of members based on an object recognition result obtained using a range sensor and a member recognition result obtained using the captured image.

11. The guidance device according to claim 10,
wherein the guidance control unit determines a breakaway member based on a detection result of the positions of the plurality of members and performs a warning operation in accordance with the behavioral abilities of the breakaway member that has been determined.

12. The guidance device according to claim 1,
wherein when an obstacle has been detected, the guidance control unit generates a route plan that avoids the obstacle in accordance with the behavioral abilities of the plurality of members, and performs the guidance control based on the route plan generated.

13. The guidance device according to claim 1,
wherein the behavioral abilities include at least one of physical behavioral abilities and intellectual behavioral abilities.

14. A guidance method comprising:
obtaining behavioral abilities of a plurality of members using a behavioral ability obtainment unit; and
performing guidance control for the plurality of members using a guidance control unit based on the behavioral abilities obtained by the behavioral ability obtainment unit.

15. A program that causes a computer to execute guidance control, the program comprising:
a process of obtaining behavioral abilities of a plurality of members; and
a process of performing guidance control for the plurality of members based on the behavioral abilities obtained.
